(19) United States
(12) Patent Application Publication
(10) Pub. No.: US 2023/0000023 A1
(43) Pub. Date: Jan. 5, 2023

(54) FAST FILLING AND DRAINING VALVE ASSEMBLY AND ASSOCIATED SYSTEM

(71) Applicant: Invertigro Pty Ltd, Rosebery, New South Wales (AU)

(72) Inventors: Benestine Lee, New South Wales (AU); Todd EBERLINE, New South Wales (AU); Paul MILLETT, New South Wales (AU); Neill WAINWRIGHT, New South Wales (AU)

(21) Appl. No.: 17/779,450

(22) PCT Filed: Nov. 26, 2020
(86) PCT No.: PCT/AU2020/051279

§ 371 Date: May 24, 2022

(30) Foreign Application Priority Data
Nov. 26, 2019 (AU) 2019904461

(51) Int. Cl. A01G 9/02; A01G 31/06; F16K 1/12; F16K 31/12

(52) U.S. Cl. CPC A01G 9/022; A01G 31/06; F16K 1/126; F16K 31/12

(57) ABSTRACT

The following disclosure relates to a valve assembly for allowing filling and draining of a container with a liquid, preferably for use in growing plants, the valve comprising: a filling catchment containing at least one opening for receiving liquid and at least one drainage orifice, the filling catchment being located within the container; a draining outlet adapted to convey liquid out of the container; a plugging member configured to move between a first position where the plugging member allows liquid to flow into the draining outlet and a second position where the plugging member prevents liquid from flowing through the draining outlet; and a biasing member which acts to retain the plugging member in the first position unless a force is applied above a predetermined value. Also provided are systems including and methods of using said valve assembly.

### TECHNICAL FIELD

The present disclosure relates to a valve assembly and associated system for allowing a container to be filled with a liquid and consequently drained, in particular for use in growing plants through a fill and drain method.

### BACKGROUND OF THE DISCLOSURE

Many applications exist where it is advantageous for a container, or series of containers to be successively filled and drained with a liquid. One such application is in the field of hydroponics, where a common method of providing water to the plants or crops being grown is through a flood/drain system, which is also commonly referred to as an ebb/flow or a fill/drain system. For ease of understanding, the term flood/drain will be used throughout this specification.

Unlike other hydroponic methods such as nutrient film technique or deep water culture where the roots of the plants being grown are constantly submerged in water, flood/drain systems leave the roots of the plants exposed to air. This allows the plants to be sufficiently oxygenated without the need to artificially oxygenate the water system. To provide the required water to the plants, flood/drain systems rely on a two phase system. In the first “flood” phase, a grow tray containing the plants is filled with liquid (water or a nutrient solution) to a predetermined height as quickly as possible. Once the “flood” phase is over, the “drain” phase begins, wherein water is quickly drained from the tray. The quick draining has the secondary effect of pulling oxygen towards the root structure as the water drains, further promoting healthy roots and oxygenation of these roots.

Typical flood/drain systems work by providing a reservoir or similar holding tank below the grow tray and using a pump to fill the tray through a flush-mounted port on the bottom of the grow tray. An overflow port is also provided in the grow tray to set the height to which the grow tray is filled to. This overflow port redirects excess water back to the reservoir. Once the pump is stopped, the remaining water in the grow tray returns through the flush-mounted port back to the reservoir, draining the tray. A timer is used to periodically turn on and off the pump, the frequency and duration of which are chosen depending on the plants being grown.

Flood/drain systems are comparatively simpler and in many cases produce healthier plants than other hydroponic systems, and accordingly, they have been studied with some interest with a view to adapting or creating flood/drain systems for large scale or commercial use. A big hurdle however, in the development of these systems is that these larger scale hydroponic set-ups require a number of vertically stacked grow trays to achieve optimum space usage. These systems may also be referred to in the art as multi-tiered systems. Currently, flood/drain systems pose an issue as they require a number of plumbing connections between each vertically stacked tray, which adds to the complexity of the system as well as the difficulty in removing trays for harvesting etc.

Similar problems exist in other non-vertically stacked operations where the grow trays are moved along conveyor belts or similar to maximize automation of the process. In these instances, the required connections to the reservoir make such a system unfeasible.

The present invention seeks to at least partially overcome these problems, enabling use of a flood/drain system on larger scale growing operations, in particular but not limited to those using grow trays that are vertically stacked and/or moved/transported by automated or semi-automated means such as through a conveyor belt, chain or rollers. The present invention may also be advantageous for other systems in which containers or irrigation channels require filling and draining.

### SUMMARY OF THE INVENTION

In a first broad aspect, there is provided a valve assembly for allowing filling and draining of a container with a liquid, comprising: a filling catchment containing at least one opening for receiving liquid and at least one drainage orifice, the filling catchment being located within the container; a draining outlet adapted to convey liquid out of the container; a plugging member configured to move between a first position where the plugging member allows liquid to flow into the draining outlet and a second position where the plugging member prevents liquid from flowing through the draining outlet; and a biasing member which acts to retain the plugging member in the first position unless a force is applied above a predetermined value.

In certain embodiments, the plugging member is positioned at least partially over the draining outlet.

In certain embodiments, the movement from the first to the second position takes place in a substantially vertical direction.

In certain embodiments, the movement from the first to the second position takes place in an arc-like direction.

In certain embodiments, at least one of the filling catchment and the plugging member are connected to a pivotable arm.

In certain embodiments, the at least one drainage orifice allows the flow of liquid out of the container.

In certain embodiments, the flow of liquid out of the container through the drainage orifice is slower than the flow of liquid out of the container through the drainage outlet when the plugging member is in the first position.

In certain embodiments, the plugging member includes a channel connected to the drainage orifice for conveying liquid out of the container.

In certain embodiments, the plugging member comprises a plug sized to fit the draining outlet.

In certain embodiments, the plug is at least partially hemi-spherical in shape.

In certain embodiments, the plug is at least partially frusto-conical in shape.

In certain embodiments, the plugging member further comprises a rod that is at least partially disposed within a tube that does not move when the plugging member moves from the first to the second position or vice versa.

In certain embodiments, the tube is connected to a drainage enclosure which at least partially encapsulates the plugging member and at least a first end of the drainage outlet, and wherein the drainage enclosure allows fluid flow from an interior of the container to the drainage outlet.

In certain embodiments, the biasing member comprises a spring.

In certain embodiments, the filling catchment is at least partially frusto-conical or conical in shape.

In certain embodiments, the plugging member moves from the first position to the second position while liquid enters into the opening of the filling catchment, and returns from the second position to the first position when liquid ceases to be poured into the opening of the filling catchment.

In certain embodiments, the assembly further comprises an overflow outlet which defines a maximum height of the liquid in the container.

In certain embodiments, the overflow outlet is adapted to be adjustable such that the maximum height that the container can be filled to can be changed by a user.

In certain embodiments, the filling catchment includes a mesh or grate at least partially over the at least one drainage outlet.

According to a second aspect, there is provided a container capable of being filled and drained, including a valve assembly according to the first aspect.

According to a third aspect, there is provided a system for filling and draining containers, comprising: a plurality of containers, each container including a valve assembly, wherein each valve assembly comprises: a filling catchment containing at least one opening for receiving liquid and at least one drainage orifice, the filling catchment being located within the container; a draining outlet adapted to convey liquid out of the container; a plugging member configured to move between a first position where the plugging member allows liquid to flow into the draining outlet and a second position where the plugging member prevents liquid from flowing through the draining outlet; and a biasing member which acts to retain the plugging member in the first position unless a force is applied above a predetermined value; a holding tank containing a liquid; a conduit for allowing the flow of the liquid from the holding tank to the at least one opening of the valve assembly of at least one of the containers; wherein no physical connection exists between the conduit and the at least one opening to which it allows the flow of liquid to.

In certain embodiments, the valve assembly is an assembly according to the first aspect.

In certain embodiments, the system is configured to allow a user to insert and/or remove containers from the system.

In certain embodiments, each the plurality of containers are vertically arranged to allow at least one of: conveying liquid from the drainage outlet of the associated valve assembly towards the opening of the valve assembly of another container; and/or receiving liquid into the opening of the associated valve assembly from the drainage outlet of the valve assembly of another container.

In certain embodiments, at least one of the containers includes an overflow outlet which is configured so that liquid that passes through the overflow outlet is conveyed towards the opening of the valve assembly of another container.

In certain embodiments, the conduit allows the flow of liquid from the holding tank to the at least one opening of the valve assembly of one of the containers.

In certain embodiments, the system is configured to allow a user to insert and/or remove containers from the system, and the system is arranged so that when a container is removed, liquid that would be otherwise be conveyed into that container is instead conveyed into another container located below the removed container.

In certain embodiments, the holding tank is located below the plurality of containers.

In certain embodiments, the system further comprises a pump for conveying liquid from the holding tank to the conduit.

In certain embodiments, the containers are trays for growing plants and the liquid is water or nutrient enriched water.

According to a fourth aspect, there is provided a method for filling and draining containers, comprising: providing a plurality of vertically arranged containers, wherein each container includes: a valve assembly according to the first aspect; wherein each the plurality of containers are vertically arranged to allow at least one of: conveying liquid from the drainage outlet of the associated valve assembly towards the opening of the valve assembly of another container; or receiving liquid into the opening of the associated valve assembly from the drainage outlet of the valve assembly of another container; conveying liquid into the opening of an uppermost container for predetermined periods at predetermined intervals so as to fill the plurality of containers.

In certain embodiments, each container includes an overflow outlet adapted to be adjustable so that the maximum level the container can be filled to can be changed, and the method further includes adjusting the overflow outlet to define a predetermined level that the container can be filled to.

In certain embodiments, the liquid is conveyed to the uppermost container from a holding tank.

In certain embodiments, the holding tank is connected to a conduit and a nozzle located to convey liquid into the uppermost container, and the liquid is conveyed at least partially by the use of a pump in fluid communication with the holding tank.

In certain embodiments, at least one of the predetermined times and intervals are controlled by a pump in fluid communication with the holding tank.

### BRIEF DESCRIPTION OF THE FIGURES

The present disclosure will become better understood from the following detailed description of various non-limiting embodiments thereof, described in connection with the accompanying figures, wherein:

FIG. 1 shows a system of vertically stacked grow trays according to the prior art.

FIG. 2 shows a system of vertically stacked grow trays according to the present invention.

FIG. 3A shows a valve assembly according to the present invention in a first position.

FIG. 3B shows a valve assembly according to the present invention in a second position.

FIG. 4A shows a close up of the plugging mechanism of the valve assembly of FIG. 3 in a first position.

FIG. 4B shows a close up of the plugging mechanism of FIG. 4A moving between a first and second position.

FIG. 4C shows a close up of the plugging mechanism of FIG. 4A in a second position.

FIG. 5A shows a side view of another embodiment of a valve assembly for filling and draining containers.

FIG. 5B shows a top view of the same embodiment of a valve assembly as in FIG. 5A.

FIG. 6 shows a cross-sectional view of an embodiment of a valve assembly and associated container.

FIG. 7 shows an example of a system for growing plants using containers which may be filled and drained.

### DETAILED DESCRIPTION

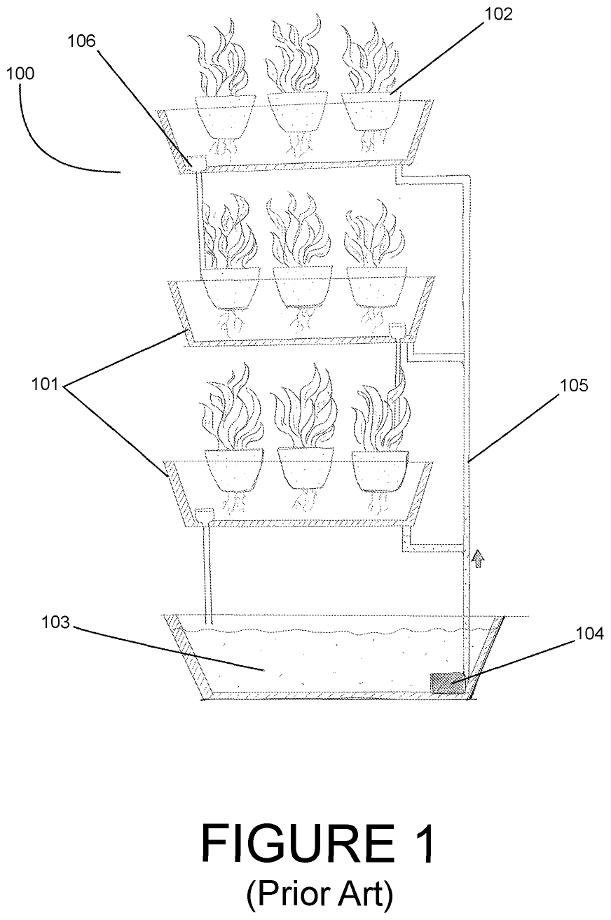

FIG. 1 shows a conventional flood/drain system 100 in which a series of grow trays 101 for growing plants 102 are arranged vertically. A holding tank or reservoir 103 is positioned under the grow trays 101 and includes a pump 104 and a conduit 105 which is connected to each grow tray. There is a check valve (not shown) between the conduit and each tray except the uppermost tray. This check valve prevents liquid from entering the tray from the conduit, as well as prevents liquid from leaving the tray while the pump is active due to the pressure exerted by the pump. Each grow tray is also provided with an overflow outlet 106 which is connected to the grow tray below, with the exception of the bottommost tray which is connected to the reservoir 103.

The flooding/draining of the grow trays 101 is carried out in this system through the following method. The pump 104 is turned on, conveying liquid from the reservoir 103 up through the conduit 105 as shown by the arrow in FIG. 1. The liquid is prevented from entering all but the uppermost tray by the check valves. The uppermost tray is filled to a predetermined height set by the height of the overflow outlet 106. As liquid continues to enter the uppermost tray, it is directed through the overflow outlet into the tray below which then fills with liquid until the height set by the overflow outlet is reached, wherein liquid flows into the next tray, and so on until liquid returns to the reservoir via the overflow outlet of the bottommost tray. When the pump is turned off, liquid drains from each tray through the conduit, the check valves now allowing liquid to flow in the opposite direction, leaving each tray and returning to the reservoir.

Such a system requires at least one connection between the conduit and each tray, if not a further connection between adjacent trays in the form of the overflow outlet. This limits the adaptability of the system, as the addition or removal of trays requires connecting or disconnecting trays from the conduit, and hinders the ability of a user to remove the trays for planting or harvesting. This is particularly a problem in larger scale operations where it may be advantageous to automate or semi-automate the planting/harvesting processes. In these operations, the ability of a user or autonomous/semi-autonomous vehicle to remove the tray and deliver it to a location for planting/harvesting by workers or machinery is complicated by the need to disconnect and reconnect these connections. Currently, this is only possible for nutrient film technique or deep water culture systems, which provide less healthy crops and reduced yield compared to those grown by flood/drain systems but which do not require these connections.

The present invention seeks to provide a valve and associated system which overcomes these issues by providing a system wherein no direct connections are required between the growing trays. This is accomplished by the use of a novel valve assembly configured to fill a container while liquid is poured into it and drain the same container when liquid ceases to be poured into the assembly. This valve assembly may further convey liquid into the valve assembly of another container when draining to create a multi-tiered system.

The present disclosure will become better understood from the following examples of non-limiting embodiments.

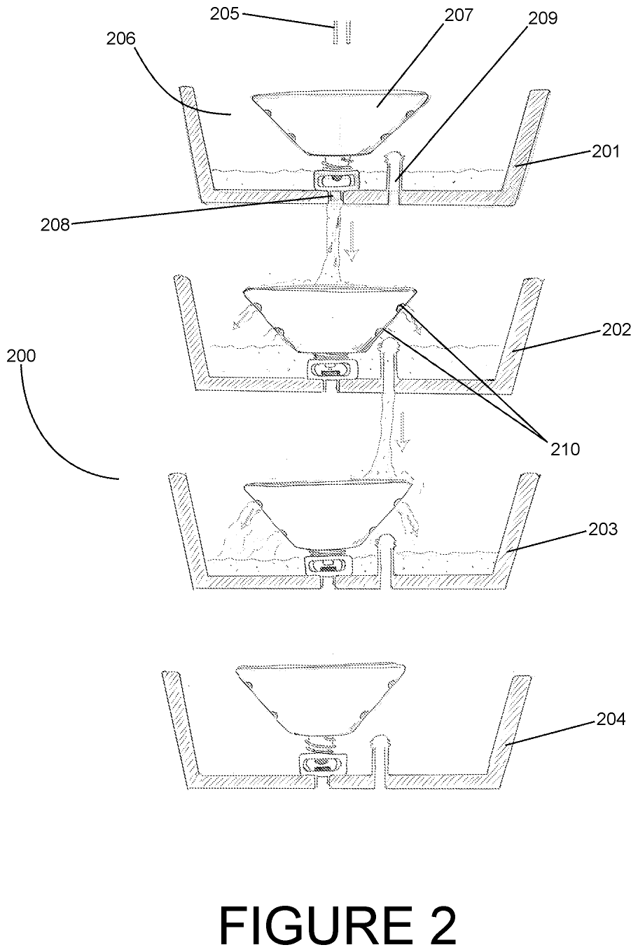

FIG. 2 shows a system 200 consisting of a series of four vertically arranged grow trays 201, 202, 203, 204. It will be understood that the number of trays is more or less arbitrary, and other embodiments may include more or fewer trays. The system also includes a reservoir, pump and conduit (not shown in this figure), and it will be understood that any known reservoir, pump and conduit combination may be used provided that the combination can convey liquid stored in the reservoir to a nozzle 205 or other suitable outlet located above the uppermost grow tray 201. In some embodiments, the reservoir, pump and conduit may be substantially similar to those in existing systems (with any direct connections between the conduit and the trays removed), reducing the cost of converting an existing growing system.

Each grow tray is provided with a valve assembly 206, comprising a filling catchment 207 and a drainage outlet 208. The drainage outlet is sized to fit into an opening in the grow tray so that liquid can pass out of the grow tray through the drainage outlet. The filling catchment in this embodiment has a plurality of drainage orifices or openings 210 which allow liquid to leave the filling catchment and enter the interior of the tray. Each grow tray also includes an overflow outlet 209 which sets a maximum height to which the grow tray may be filled.

In FIG. 2, the system is in a state where the pump has been turned off and stopped conveying liquid through the nozzle 205, following a previous phase where the liquid was passing through the nozzle 205 into the uppermost grow tray 201. In this embodiment, water is envisioned as the liquid passing through the system. As a result, the filling catchment is empty as all water has left through the openings 210 into the interior of the grow tray. Because water is not flowing into the filling catchment, the filling catchment is in a first position where water can flow out of the grow tray through the drainage outlet 208 as shown in the figure.

The water flowing out of the uppermost grow tray 201 through drainage outlet 208 is conveyed into the filling catchment 207 of the second tray 202. As water continues to flow from the uppermost container 201 into the filling catchment, the filling catchment is moved into a second position preventing liquid from exiting the grow tray 202. As shown in the figure, water is constantly draining from the openings 210 in the filling catchment of grow tray 202 such that when the uppermost grow tray 201 is drained of water and ceases to convey water to the valve assembly of grow tray 202, the filling catchment of grow tray 202 will move to a first position and allow the second grow tray 202 to drain into the third grow tray 203. FIG. 2 also shows the situation wherein the second grow tray 202 has been filled to the maximum height allowed by the overflow outlet 209. Excess water that passes into the overflow outlet is conveyed to the filling catchment of the third tray 203, and begins to fill the third tray.

The valve assembly of the third tray 203 is moved into the second position by the flow of water from the overflow outlet of the second tray 202. This prevents water from flowing out of the third tray which has begun to fill. As the water in the third tray has not reached the height set by the overflow outlet, no water has entered the fourth tray 204, and accordingly the valve assembly within the fourth tray is in the first position. In this embodiment, the drainage outlet and overflow outlet of the fourth tray 204 convey water back to the reservoir. It will be understood that in other embodiments, the fourth tray may instead convey water to a fifth tray, or there may be only three trays, the third tray conveying water to the reservoir, or any other number of trays wherein the bottommost tray returns water to the reservoir.

In some embodiments, the overflow outlet 209 is able to be adjusted to define different maximum heights to which the grow trays can be filled. This may be accomplished by any known methods, such as providing a telescoping or extending mechanism within the body of the overflow outlet. This allows a user to optimize the flood/drain system in each tray for the particular crop being grown or the particular root system of the plants within the grow tray.

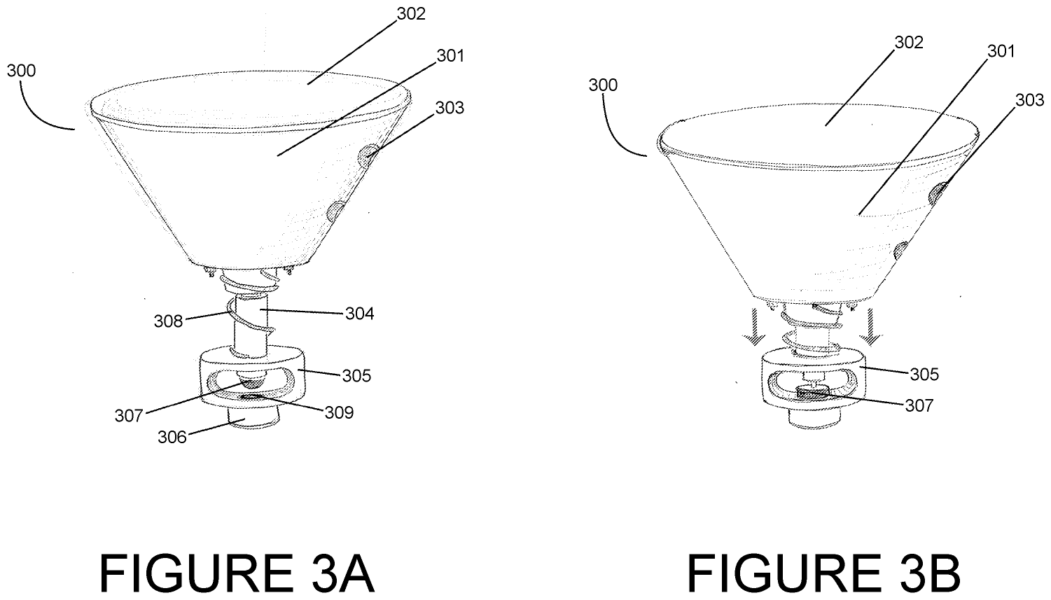

FIG. 3A shows a valve assembly 300 according to the present invention in a first position. The valve assembly 300 includes a filling catchment 301 which has a large opening 302 in which water can be conveyed as well as smaller drainage orifices or openings 303 which allow water to drain from the filling catchment. In this embodiment, these openings drain into the container, however it will be understood that in other embodiments, the openings may drain out of the container while still allowing the assembly to function. The filling catchment of this embodiment has a frusto-conical shape with the top of the filling catchment, including the opening 302, having a greater diameter than the bottom of the filling catchment. This maximizes the amount of water which can enter the filling catchment, while reducing size and encouraging draining through the smaller openings 303. This embodiment of a valve assembly is adapted to be located within a container with at least an opening in a bottom surface.

The valve assembly 300 also includes a plugging member in the form of a rod 304 and plug 307. The plugging member is movable with the filling catchment. The plug 307 is located in a drainage chamber 305 which also includes an opening 309 into the drainage outlet 306. In FIG. 3A, the filling catchment is in a first position wherein liquid can pass into the drainage outlet 306 via opening 309. A biasing member in the form of a spring 308 provides a force to bias the filling catchment into the first position unless a force is applied to the filling catchment in a direction substantially towards the opening 309. In preferred embodiments, this force is balanced to be equal to or greater the force due to the weight of a volume of water within the filling catchment greater than the volume required to reach at least some of the smaller openings 303, that is to say if there is insufficient water in the filling catchment to continue flowing out of the smaller openings, then the filling catchment moves to the first position. In this embodiment, the drainage chamber 305 is configured so that a bottom surface of the chamber contacts the bottom surface of the container in which the valve assembly is located, in a way that creates a watertight seal between the two surfaces. This only allows the flow of liquid out of the container through the drainage outlet 306 in the drainage chamber 305.

FIG. 3B shows the valve assembly of FIG. 3A in a second position. Here, the filling catchment 301 has moved in the direction of the arrows towards the drainage chamber 305, bringing the plug 307 of the plugging member into contact with the opening 309 of the drainage outlet 306 to prevent liquid from leaving the container.

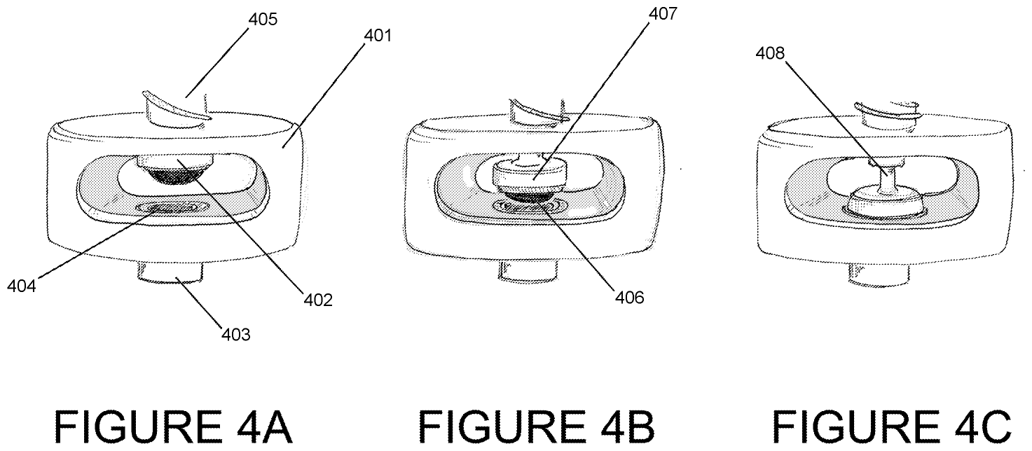

FIGS. 4A, 4B and 4C show a drainage chamber 401 and plugging member in a first, transitionary, and second position respectively. These figures show that the plugging member comprises a tube 405, rod 408, and plug 402. In the first position shown in FIG. 4A, the rod 407 is located within the tube 405 and the plug 402 is located at the top of the drainage chamber 401.

FIG. 4B shows the plugging member transitioning from a first to a second position. Here, the rod can be seen extending from the tube 405, and the shape of the plug 402 can most clearly be seen, the plug comprising a first element 406 and a second element 407. The first element in this embodiment is hemi-spherical in shape and is sized to fit into an opening 404 in the drainage chamber 401 to the drainage outlet 403. The second element 407 is sized to be larger than the opening 404. In this embodiment, the second element also has a flange around its circumference, and the opening 404 has a corresponding recess or lip which together provide a watertight seal when the plug is in the second position, as shown by FIG. 4C.

FIG. 4C most clearly shows rod 408 which is fully extended out of the tube 405 in the second position, and the plugging member prevents any liquid from flowing through the opening 404 and thus leaving the container through the drainage outlet 403.

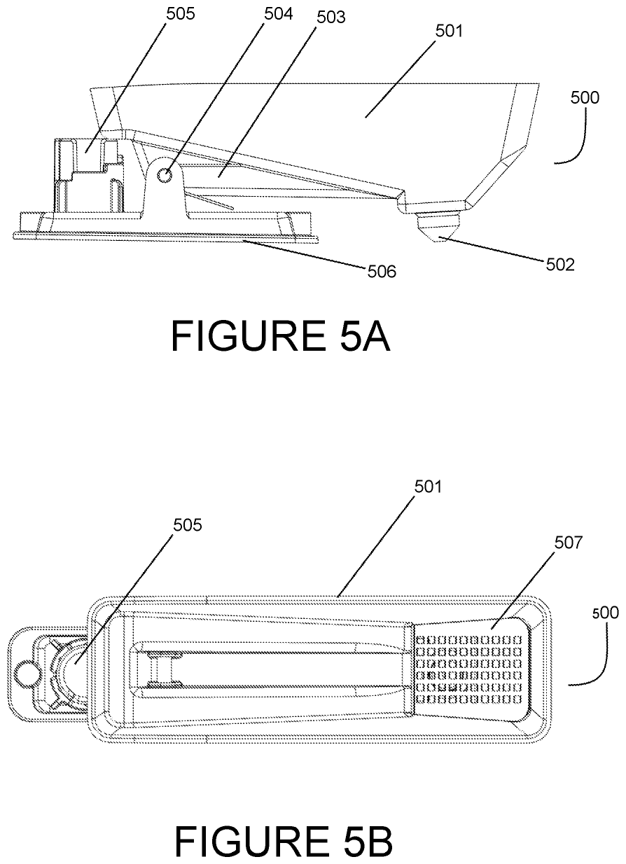

Side and top views of another embodiment of a valve assembly according to the present invention are shown in FIGS. 5A and 5B respectively. This assembly 500 includes a filling catchment 501 connected to a plugging member 502 and an arm 503 connected to a pivot 504 at an opposing end to the filling catchment. Unlike the previous embodiments, the filling catchment in this embodiment is not in a frusto-conical shape but rather is shaped such that a lower internal surface proximate the location of plugging member 502 on the opposing side is provided at a distal end of the filling catchment to the pivot 504. The internal side surfaces are sloped so that any liquid which enters the catchment is directed towards this lower surface. In this embodiment, a drainage orifice (not shown) is provided in the lower surface of the filling catchment. The plugging member is in the form of a partially frusto-conical rubber stopper in this embodiment. In preferred embodiments, the pivot may be in the form of protrusions on the arm 503 or catchment 501 which cooperate with corresponding recesses or openings in a base 506 to provide the pivoting function. It will be understood that in other embodiments, other known methods of providing a pivoting function may be used without departing from the spirit of the invention.

This embodiment also includes an adjustable overflow outlet 505 which is located on the base 506 which also is connected to the pivot 504. The base 506 can be attached to a container through any known methods, such as by screws or bolts. The adjustable overflow outlet 505 may be adjusted, for example, by the use of a castle nut. As in the previous embodiments, the overflow outlet acts to create a maximum height within the container for a liquid to fill to. A grate or mesh 507 is also provided in the filling catchment located over the drainage orifices to prevent any solids (such as soil particles) from blocking the drainage orifices.

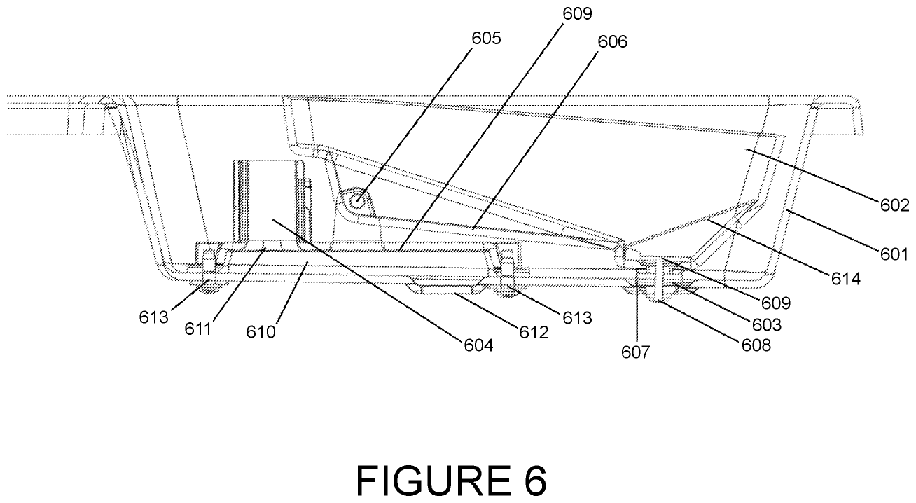

A cross-sectional view of the embodiment of FIGS. 5A and 5B is shown in place in a container in FIG. 6. The assembly located within the container 601 comprises filling catchment 602, plugging member 603, overflow outlet 604, pivot 605 and arm 606. The overflow outlet 604 and pivot 605 are mounted on a base 609. Drainage outlet 607 is also provided in the container 601. The plugging member 603, which is in this embodiment in the form of a partially frusto-conical shaped rubber stopper, has an internal channel 608 which is connected to a drainage orifice 609 located in a lower surface of the filling catchment 602.

FIG. 6 also includes an adjustable overflow outlet 604 which is located on base 609 which includes an internal overflow channel 610 in fluid communication with the overflow outlet at a first end 611 and an exterior of the container at a second end 612. The first and second ends of the channel are offset such that liquid is conveyed towards the same location as the drainage outlet 607. The base 609 in this embodiment is attached to the container 601 by means of screws 613. It will be understood that in other embodiments, the base may be connected to the container by other methods, or integrated into the container itself. The cross-sectional view also shows that a mesh or grate 614 which is positioned over the drainage orifice 609 so that solids, for example soil particles or other contaminants, cannot cause the orifice to become clogged over repeated filling and draining processes.

In the embodiments of FIGS. 5 and 6, the pivot causes the filling catchment and the plugging member to be movable in an arc-like motion from a first ‘upper’ position to a second ‘lower’ position, wherein a drainage outlet in the container is sealed by the plugging member in the second position. FIG. 5A shows the plugging member 502 in a first position while FIG. 6 shows the plugging member 603 in a second position. A biasing member, for example a spring located under the arm, is provided to bias the filling catchment and plugging member into the first position unless a force is applied to overcome it. In preferred embodiments, the biasing member is in the form of a compression spring located at a distal end of the base to the pivot, though it will be understood that in other embodiments, other biasing means may be used instead. As in the other embodiments, the force required to move the filling catchment may be balanced against the weight of liquid within the filling catchment, such that the catchment moves from the first position to the second position when the catchment is partially or substantially filled with water. Additionally or alternatively, the force required to overcome the biasing member may be balanced against the force exerted by water entering the filling catchment from a height, preferably where the height is the distance between the drainage outlet of the container above and the filling catchment of the valve assembly.

By arranging the assembly in this manner, the overall height of the valve can be reduced relative to the previous embodiment, allowing more containers to be fitted a system of equivalent volume. Further, assemblies with this reduced height may be retrofitted to existing systems which may have low clearance between containers. The arcuate motion of the plugging member may also act to reduce the chance of the filling catchment becoming stuck on the biasing member when the plugging member moves between positions relative to movements in a vertical direction.

Rather than the filling catchment containing a number of drainage orifices which convey liquid into the container as in the embodiments of FIGS. 2-4, the embodiments of FIGS. 5A, 5B and 6 include a single drainage orifice in a lower surface of the catchment, as well as an internal channel within the plugging member. Any liquid within the filling catchment in this embodiment is thus conveyed through this internal channel and out of the container.

Thus, when liquid is poured into the filling catchment in this embodiment, the filling catchment and plugging member move to the second position where liquid cannot flow through the drainage outlet of the container. The drainage orifice and internal channel of the plugging member are sized to only allow a reduced flow of liquid relative to the drainage outlet, such as by providing the orifice and/or channel with a smaller diameter than the drainage outlet. As a result, liquid will leave the filling catchment far slower than liquid will enter the catchment, filling the catchment to the point it overflows and fills the container. Liquid will constantly drain at a slow rate from the drainage orifice and channel out of the filling catchment, preferably into the filling catchment of a second container or a reservoir for re-use. As the amount of liquid in the filling catchment decreases, the biasing member will act to bring the plugging member back into the first position, allowing the liquid that has filled the container to rapidly drain. The liquid can be directed into the filling catchment of a second container, repeating the process in a similar manner as described in respect to the previous embodiments. In some embodiments, the amount and rate of liquid conveyed through the drainage orifice may be insufficient to cause the plugging member of the second valve assembly to move, in other embodiments the flow of liquid may begin the flooding process for the second container prior to the draining process beginning in the first container.

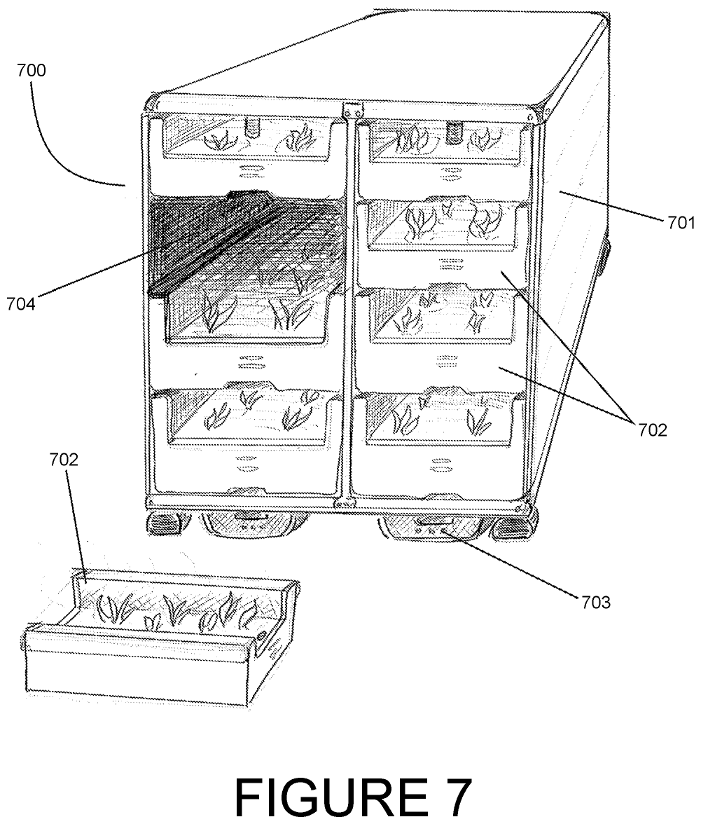

As an example of a potential application for the aforementioned valve assemblies and systems, FIG. 7 shows a perspective view of a system for growing plants according to the present invention. System 700 consists of a housing 701, in which two columns or stacks of vertically arranged grow trays 702 can be seen, as well as a reservoir 703 under each column. Not visible in this figure is a conduit that extends inside the wall of the housing 701 capable of conveying liquid from the reservoir to the uppermost grow tray, wherein a valve assembly as described in FIGS. 2-4 or FIGS. 5-6 is located in each grow tray. In the system of FIG. 7, one grow tray 702 has been removed from the system, showing the absence of any direct connections for channeling liquid in and out of the grow tray. The removal of the grow tray has left a space 704. Such a space may include a drawer-like sliding mechanism or other method of allowing a tray to easily slide in and out of the column.

While the embodiments above have been described in reference to vertically stacked growing trays, it will be appreciated that the valve assembly may be used in any sort of hydroponic operation where trays are removed/replaced for harvesting/planting. For instance, this valve may be particularly suited to operations which utilize a conveyor belt for easy harvesting, as no connections are required between a grow tray and a reservoir and a nozzle for dispensing water or other nutrient solution may be provided above the conveyor belt for supplying liquid to the grow trays.

In some other embodiments, the valve assembly may be particularly suited for use as part of a modular hydroponic system where more trays can easily be added to the system without requiring the additional trays to be connected to any form of conduit.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A valve assembly for allowing filling and draining of a container with a liquid, comprising:
a filling catchment containing at least one opening for receiving liquid and at least one drainage orifice, the filling catchment being located within the container;
a draining outlet adapted to convey liquid out of the container;
a plugging member configured to move between a first position where the plugging member allows liquid to flow into the draining outlet and a second position where the plugging member prevents liquid from flowing through the draining outlet; and
a biasing member which acts to retain the plugging member in the first position unless a force is applied above a predetermined value.

2. The valve assembly according to claim 1, wherein the plugging member is positioned at least partially over the draining outlet.

3. The valve assembly according to either claim 1, wherein the movement from the first to the second position takes place in a substantially vertical direction.

4. The valve assembly according to either claim 1, wherein the movement from the first to the second position takes place in an arc-like direction.

5. The valve assembly according to claim 4, wherein at least one of the filling catchment and the plugging member are connected to a pivotable arm.

6. The valve assembly according to claim 1, wherein the at least one drainage orifice allows the flow of liquid out of the container.

7. The valve assembly according to claim 6, wherein the flow of liquid out of the container through the drainage orifice is slower than the flow of liquid out of the container through the drainage outlet when the plugging member is in the first position.

8. The valve assembly according claim 6, wherein the plugging member includes a channel connected to the drainage orifice for conveying liquid out of the container.

9. The valve assembly according to claim 1, wherein the plugging member comprises a plug sized to fit the draining outlet.

10. The valve assembly according to claim 9, wherein the plug is at least partially hemi-spherical in shape.

11. The valve assembly according to claim 9, wherein the plug is at least partially frusto-conical in shape.

12. The valve assembly according to claim 9, wherein the plugging member further comprises a rod that is at least partially disposed within a tube that does not move when the plugging member moves from the first to the second position or vice versa.

13. The valve assembly according to claim 12, wherein the tube is connected to a drainage enclosure which at least partially encapsulates the plugging member and at least a first end of the drainage outlet, and wherein the drainage enclosure allows fluid flow from an interior of the container to the drainage outlet.

14. The valve assembly according to claim 1, wherein the biasing member comprises a spring.

15. The valve assembly according to claim 1, wherein the filling catchment is at least partially frusto-conical or conical in shape.

16. The valve assembly according to claim 1, wherein the plugging member moves from the first position to the second position while liquid enters into the opening of the filling catchment, and returns from the second position to the first position when liquid ceases to be poured into the opening of the filling catchment.

17. The valve assembly according to claim 1, wherein the assembly further comprises an overflow outlet which defines a maximum height of the liquid in the container.

18. The valve assembly according to claim 17, wherein the overflow outlet is adapted to be adjustable such that the maximum height that the container can be filled to can be changed by a user.

19. The valve assembly according to claim 1, wherein the filling catchment includes a mesh or grate at least partially over the at least one drainage outlet.

20. A container capable of being filled and drained, including a valve assembly according to claim 1.

21. A system for filling and draining containers, comprising:
a plurality of containers, each container including a valve assembly, wherein each valve assembly comprises:
a filling catchment containing at least one opening for receiving liquid and at least one drainage orifice, the filling catchment being located within the container;
a draining outlet adapted to convey liquid out of the container;
a plugging member configured to move between a first position where the plugging member allows liquid to flow into the draining outlet and a second position where the plugging member prevents liquid from flowing through the draining outlet; and
a biasing member which acts to retain the plugging member in the first position unless a force is applied above a predetermined value;
a holding tank containing a liquid;
a conduit for allowing the flow of the liquid from the holding tank to the at least one opening of the valve assembly of at least one of the containers;
wherein no physical connection exists between the conduit and the at least one opening to which it allows the flow of liquid to.

22. The system according to claim 21, wherein the valve assembly is a valve assembly for allowing filling and draining of a container with a liquid, comprising:
a filling catchment containing at least one opening for receiving liquid and at least one drainage orifice, the filling catchment being located within the container;
a draining outlet adapted to convey liquid out of the container;
a plugging member configured to move between a first position where the plugging member allows liquid to flow into the draining outlet and a second position where the plugging member prevents liquid from flowing through the draining outlet; and a biasing member which acts to retain the plugging member in the first position unless a force is applied above a predetermined value.

23. The system according to claim 21, wherein the system is configured to allow a user to insert and/or remove containers from the system.

24. The system according to claim 21, wherein each the plurality of containers are vertically arranged to allow at least one of:
conveying liquid from the drainage outlet of the associated valve assembly towards the opening of the valve assembly of another container; and/or
receiving liquid into the opening of the associated valve assembly from the drainage outlet of the valve assembly of another container.

25. The system according to claim 24, wherein at least one of the containers includes an overflow outlet which is configured so that liquid that passes through the overflow outlet is conveyed towards the opening of the valve assembly of another container.

26. The system according to claim 24, wherein the conduit allows the flow of liquid from the holding tank to the at least one opening of the valve assembly of one of the containers.

27. The system according to claim 24, wherein the system is configured to allow a user to insert and/or remove containers from the system, and the system is arranged so that when a container is removed, liquid that would be otherwise be conveyed into that container is instead conveyed into another container located below the removed container.

28. The system according to claim 21, wherein the holding tank is located below the plurality of containers.

29. The system according to claim 21, further comprising a pump for conveying liquid from the holding tank to the conduit.

30. The system according to claim 21, wherein the containers are trays for growing plants and the liquid is water or nutrient enriched water.

31. A method for filling and draining containers, comprising:
providing a plurality of vertically arranged containers, wherein each container includes:
a valve assembly according to any one of claims 1 to 19;
wherein each the plurality of containers are vertically arranged to allow at least one of:
conveying liquid from the drainage outlet of the associated valve assembly towards the opening of the valve assembly of another container; or
receiving liquid into the opening of the associated valve assembly from the drainage outlet of the valve assembly of another container;
conveying liquid into the opening of an uppermost container for predetermined periods at predetermined intervals so as to fill the plurality of containers.

32. The method according to claim 31, wherein each container includes an overflow outlet adapted to be adjustable so that the maximum level the container can be filled to can be changed, and the method further includes adjusting the overflow outlet to define a predetermined level that the container can be filled to.

33. The method according to claim 31, wherein the liquid is conveyed to the uppermost container from a holding tank.

34. The method according to claim 33, wherein the holding tank is connected to a conduit and a nozzle located to convey liquid into the uppermost container, and the liquid is conveyed at least partially by the use of a pump in fluid communication with the holding tank.

35. The method according to claim 34, wherein at least one of the predetermined times and intervals are controlled by a pump in fluid communication with the holding tank.
